(19) United States
(12) Patent Application Publication
(10) Pub. No.: US 2004/0249620 A1
(43) Pub. Date: Dec. 9, 2004

(54) Epistemic engine

(75) Inventors: D. Navin Chandra, Framingham, MA (US); Keith O. Elliston, Sudbury, MA (US); David A. Kightley, York, ME (US)

Correspondence Address: TESTA, HURWITZ & THIBEAULT, LLP, HIGH STREET TOWER, 125 HIGH STREET, BOSTON, MA, 02110, US

(73) Assignee: Genstruct, Inc., Cambridge, MA

(21) Appl. No.: 10/717,224

(22) Filed: Nov. 19, 2003

Related U.S. Application Data
(60) Provisional application No. 60/427,755, filed on Nov. 20, 2002.
(60) Provisional application No. 60/504,746, filed on Sep. 19, 2003.

(51) Int. Cl. G06N 5/02; G06F 17/00; G06F 15/18; G06N 3/12; G06N 3/00; G06G 7/58; G06G 7/48

(52) U.S. Cl. 703/11; 706/46; 706/13

(57) ABSTRACT

An epistemic engine system and methods are provided, which accept biological data from experiments or other sources, and automatically produce a model, such as a genomic and protein interaction network, which attempts to explain the operation of a biological system. The system and methods identify interrelationships among components of a biological system, consistent with the biological data and other life science knowledge. In preferred embodiments, evolutionary algorithms are used, in combination with information from a life science knowledge base and experimental data, to generate models that may identify these interrelationships. The output of an epistemic engine permits scientists to better understand biological systems, to propose hypotheses, to build more complete models, and to propose new experiments to test the validity of their hypotheses.

### RELATED APPLICATIONS

This application claims the benefit of U.S. provisional application No. 60/427,755, entitled “Epistemic Engine,” filed Nov. 20, 2002, and U.S. provisional application No. 60/504,746, entitled “Epistemic Engine,” filed Sep. 19, 2003, the entire disclosures of each of which are incorporated by reference herein.

### TECHNICAL FIELD

The invention relates to methods and apparatus for developing knowledge of structures constituting living systems and biophysical, biomedical and biochemical interrelationships among those structures responsible for life processes. More particularly, the invention relates to methods and computing devices that can discover, discern, amplify, verify, supplement, and attempt to perfect biological knowledge within complex biological data sets.

### BACKGROUND

Biological knowledge addresses the origins, history, structures, functions, and interrelationships of living systems. Its complexity arises from interactions among nutrients, drugs, biomolecules, organelles, cells, tissues, organisms, colonies, ecologies, and the biosphere. Knowledge about the web of life expands each second. Biological observations and data from experiments now accumulate at a truly remarkable rate.

In the tradition of the scientific method, data designed to test a hypothesis have been generated using sophisticated tools, analyzed, converted to “knowledge,” and reported for use, verification and expansion by others as hypotheses or established facts in publicly accessible books and papers. Data are converted to knowledge by the intellectual labors of humans trying to make sense of the world around them. This paradigm of modern science has accumulated vast and diverse bodies of knowledge, and enables scientists, engineers, physicians, and medicinal chemists to understand and exploit biology for the improvement of human health.

While scientific progress continues, and biophysical data generation accelerates, ironically, the human mind is becoming the bottleneck to learning and discovery. Knowledge generation simply cannot keep pace with data generation. Molecular biology tools produce lots of data but few new insights. The number of drug targets increases but there are fewer new drugs. Mountains of diverse biological data await mining, and countless connections as yet unknown will lead to new understanding, therapies, longevity, disease prevention, quality of life improvements, and advances in food production, ecological preservation and enhancement.

Unfortunately, a cognitive barrier to gaining the understanding of life science knowledge that will lead to these benefits has emerged: the human mind is incapable of reasoning with thousands of data points simultaneously, and without new analysis tools, one cannot find the threads that explain the reality of the biology. The remarkable pattern recognition capabilities of the mind are overwhelmed by multidimensional data space. The penetration of this barrier can open new frontiers of productivity.

In view of the above, what is needed in the art is a way to expand human ability to understand, make sense of, and intervene productively in complex biological systems. The focus of the present invention is on gene and protein interaction networks. With the completion of the human genome project, we now have a exhaustive sequence and list of genes. This, however, is only the “parts” list. The next challenge is to determine the function of genes. Genes interact with other genes to make life possible. Genes accomplish this through complex gene-protein and protein-protein interactions. The impact of a gene and protein interaction network may be manifested in several forms, for example, gene regulation and expression changes, RNA degradation, metabolic changes, metabolite changes, protein changes and drug response.

### SUMMARY OF THE INVENTION

The invention provides epistemic engines, that is, programmed computers which accept biological data from real or thought experiments probing a biological system, and use them to produce a network model of protein interactions, gene interactions and gene-protein interactions consistent with the data and prior knowledge about the system, and thereby deconstruct biological reality and propose testable explanations (models) of the operation of natural systems. The engines identify new interrelationships among biological structures, for example, among biomolecules constituting the substance of life. These new relationships alone or collectively explain system behavior. For example, they can explain the observed effect of system perturbation, identify factors maintaining homeostasis, explain the operation and side effects of drugs, rationalize epidemiological and clinical data, expose reasons for species success, reveal embryological processes, and discern the mechanisms of disease. The programs reveal patterns in complex data sets too subtle for detection with the unaided human mind. The output of the epistemic engine permits scientists to better understand the system under study, to propose hypotheses, to integrate the system under study with other systems, to build more complex and lucid models, and to propose new experiments to test the validity of their hypotheses.

Accordingly, in one aspect, the invention provides a method of analyzing biological, i.e., life science-related data, so as to discover biological knowledge. The method requires the construction of a program, typically embodied as software in a general purpose computer, comprising an electronic representation structure (e.g., in the form of a data and knowledge base), rules about how life science systems or other systems may be configured (e.g., from the literature), and an algorithm for generating networks composed of the objects within the representation structure. The representation structure comprises objects or “nodes” representative of known physical biological structures, conditions, or processes, and descriptors quantitatively or qualitatively representing possible types of interrelationships among nodes. For example, nodes may be biological molecules, and descriptors may be representations of the functions that a pair of molecules can have, for example, A binds with and activates B, or X cleaves and inactivates Y. The term qualitative is used to describe system features that either cannot be measured or described easily in an analytical or quantitative manner, or because of insufficient knowledge of the system in general or the feature itself, it is impossible to be described otherwise (e.g. the magnitude of the functional relationships between certain variables).

The program proposes a biological model by selecting from objects within the representation structure and specifying descriptors between selected pairs or groups of at least a portion of the objects to produce a network, web, matrix, or other form of electronic model, which at the outset may be completely or partially random. Next, the program simulates operation of the proposed biological model to produce simulated data. The simulated data then is compared to data representative of putative real biological data, e.g., data determined experimentally. Thus, the computed behaviors or properties of the hypothetical system are examined to determine their degree of consistency with observed, hypothesized, or real data. A given candidate system may be scored. The proposing, simulating, and comparing steps are repeated with different proposed systems. The systems evolve and explore fitness space. Eventually, the program arrives at an arrangement of nodes interconnected by selected descriptors defining a model which generates data which matches well with the experimentally derived data, i.e., a model whose behavior approaches duplication of the experimentally determined biological behavior or properties, and therefore gets close to biological reality.

In a preferred embodiment, the proposed biological models include some established nodes and descriptors which remain fixed through the iterative generation of models, or are weighted to bias the proposed models toward a particular form. This is done to account for knowledge that is already known from existing literature and from scientists' own experiences and from actual experiments. A portion of the models may include established relationships, and the goal of the exercise may be to expand, correct, verify, or refine knowledge. This also increases the rate of convergence toward a rational model and helps to integrate new knowledge into an existing knowledge base. Data from experiments identifying newly discovered biological structures, or known structures with unknown or partially unknown function, may be used together with data that characterize the structure, or data which indicates a functional relationship with one or more other known or newly discovered structures.

The result of the invention is a virtual, new biological model embodying new biological knowledge, for example, a web or network of new physiological pathways defined by the molecules, such as genes and proteins, which take part in the biology (nodes) and the identified relationships between the molecules (descriptors). The model represents a new hypothesis “explaining” the operation of the system, i.e., capable of producing, upon simulation, predicted data that matches the actual data that serves as the fitness criteria. The hypothesis can be tested with further experiments, combined with other models or networks, refined, verified, reproduced, modified, perfected, corrected, or expanded with new nodes and new connections based on manual or computer aided analysis of new data, and used productively as a biological knowledge base.

In preferred embodiments, the iterative proposing, simulating, and comparing steps are implemented by an evolutionary algorithm, for example, by genetic programming or a genetic algorithm. In some embodiments, the proposing step may involve any combination of: (a) creating a random plurality of possible solutions, (b) using a measure of fitness of the solution to expected results through a crossover operator applied to solutions selected from a population of solutions, and/or (c) applying a mutation operator to individual solutions or groups of solutions during or after crossover. In some embodiments, the simulating step may involve qualitative and quantitative analysis of a solution to assess how well it fits the expected results. In further embodiments, analysis is done by propagating the expected impact of an experimental intervention through the model solution to create predictions of how different genes, proteins and metabolites might change. These predictions are then compared to actual experimental results. In some embodiments, the comparing step may involve using a scoring algorithm that assigns a higher score to a closer match between predicted and actual data. Several standard scoring algorithms may be used as known in the art. In a one embodiment, a statistical correlation is used.

The preferred form of descriptors for use in the invention are case frames extracted from the representation structure which permit instantiation and generalization of the models to a variety of different life science systems or other systems. Case frames are described in detail in co-pending, co-owned U.S. patent application Ser. No. 10/644,582, the disclosure of which is incorporated by reference herein. The descriptors may further comprise quantitative functions such as differential equations representing possible quantitative relationships between pairs of nodes which may be used to refine the network further. The knowledge generation process may be conducted on disparate systems and the output combined into a consolidated model. Models of portions of a physiological pathway, or sub-networks in a cell compartment, cell, organism, population, or ecology may be combined into a consolidated model by connecting one or more nodes in one model to one or more nodes in another.

In one aspect, the invention provides a method of proposing new genomic and/or proteomic-related knowledge. Genomic-related knowledge refers to the body of knowledge relating to the study of genomes, which includes, but is not limited to, genome mapping, gene sequencing and gene function. Proteomic-related knowledge refers to the body of knowledge relating to the study of proteins, which includes, but is not limited to, identification, quantification, and characterization of proteins in particular cells, organs, or organisms. Genomic/proteomic-related knowledge refers to the body of knowledge relating to the study of the interactions and relationships between and among genomes and proteins.

Gene and protein network models include, by way of non-limiting examples, protein interaction networks, gene interaction networks, signal cascades, cell signaling pathways, gene regulatory networks and protein signaling networks. Gene and protein network models may represent, by way of non-limiting examples, biological concepts such as cell adhesion, apoptosis, cell cycle, cytokines, developmental biology models, embryology, immunology pathways, chemokines, transmembrane receptor pathways, G-coupled protein pathways, and neurological pathways.

Nodes may be, by way of non-limiting examples, biological molecules including proteins, small molecules, genes, ESTs, RNA, DNA, transcription factors, metabolites, ligands, trans-membrane proteins, transport molecules, sequestering molecules, regulatory molecules, hormones, cytokines, chemokines, histones, antibodies, structural molecules, metabolites, vitamins, toxins, nutrients, minerals, agonists, antagonists, ligands, or receptors. The nodes may be drug substances, drug candidate compounds, antisense molecules, RNA, RNAi, shRNA, dsRNA, or chemogenomic or chemoproteomic probes. Viewed from a chemistry perspective, the nodes may be protons, gas molecules, small organic molecules, amino acids, peptides, protein domains, proteins, glycoproteins, nucleotides, oligonucleotides, polysaccharides, lipids or glycolipids. Proceeding to higher order models, the nodes may be protein complexes, protein-nucleotide complexes such as ribosomes, cell compartments, organelles, or membranes. From a structural perspective, they may be various nanostructures such as filaments, intracellular lipid bilayers, cell membranes, lipid rafts, cell adhesion molecules, tissue barriers and semipermeable membranes, collagen structures, mineralized structures, or connective tissues. At still higher orders, the nodes are cells, tissues, organs or other anatomical structures, for example, in a model of the immune system, which might includes immunoglobulins, cytokines, various leucocytes, bone marrow, thymus, lymph nodes, and spleen. In simulating clinical trials the nodes may be, for example, individuals, their clinical prognosis or presenting symptoms, drugs, drug dosage levels, and clinical end points. In simulating epidemiology, the nodes may be, for example, individuals, their symptoms, physiological or health characteristics, their exposure to environmental factors, substances they ingest, and disease diagnoses.

Descriptors are the types of biological relationships between nodes and include, but are not limited to, non-covalent binding, adherence, covalent modification, multimolecular interactions (complexes), cleavage of a covalent bond, conversion, transport, change in state, catalysis, activation, stimulation, agonism, antagonism, up regulation, repression, inhibition, down regulation, expression, post-transcriptional modification, post-translational modification, internalization, degradation, control, regulation, chemoattraction, phosphorylation, acetylation, dephosphorylation, deacetylation, transportation, and transformation.

Data useful as the fitness criteria to the engine include gene expression profiles, DNA and RNA sequence data, protein sequence data, proteomic profiles, metabolomic profiles, biochemical measurements, protein activity data, calcium flux data, depolarization data, physiometric data, signaling activity data, binding data, molecular activity data, mass spectrometry data, microarray data, protein array data, biomarker data, microscoping imaging data, fluorescence imaging data, body and tissue imaging data, physiologic data, toxicological data, and clinical data.

The invention may be applied any kind of protein pathway, gene network, and gene protein network. Thus, the methods may be used to discover various types of models including models of diseased and healthy systems for comparison, protein biopathways, gene regulation, models of mechanism of diseases, mechanisms of drug resistance, cell signaling, signal transduction, kinase action networks, cell differentiation, mechanism of drug action, mechanisms of drugs in combination, mechanisms of metastasis, mechanisms of response to external perturbations, models of diagnostics, models of biomarkers, models of patient physiology, models of inter-cellular signaling, inter-organ interaction models. They may be used to discern the detailed molecular biology of microbes, pathogens, plants, or animals, especially humans.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1 is a block diagram showing an overview of an illustrative embodiment of the invention.

FIG. 2A-2C show representations of life science data and relationships, including a representation based on nodes and descriptors and a representation based on a matrix, which may be used in accordance with an illustrative embodiment of the invention.

FIG. 3 shows a matrix that represents a model of a life science system, having both known and unknown portions, in accordance with an illustrative embodiment of the invention.

FIG. 4 is a flowchart showing the operation of a model generator in accordance with an illustrative embodiment of the invention.

FIG. 5A shows a representation of a hypothesized model of a network interaction in accordance with an illustrative embodiment of the invention.

FIG. 6 is a flowchart showing a molecular epistemics algorithm of conjecture and refutation in accordance with an illustrative embodiment of the invention.

FIG. 7 shows a representation of a regulatory network in accordance with an illustrative embodiment of the invention.

FIG. 8 also shows a representation of a regulatory network in accordance with an illustrative embodiment of the invention.

### DESCRIPTION

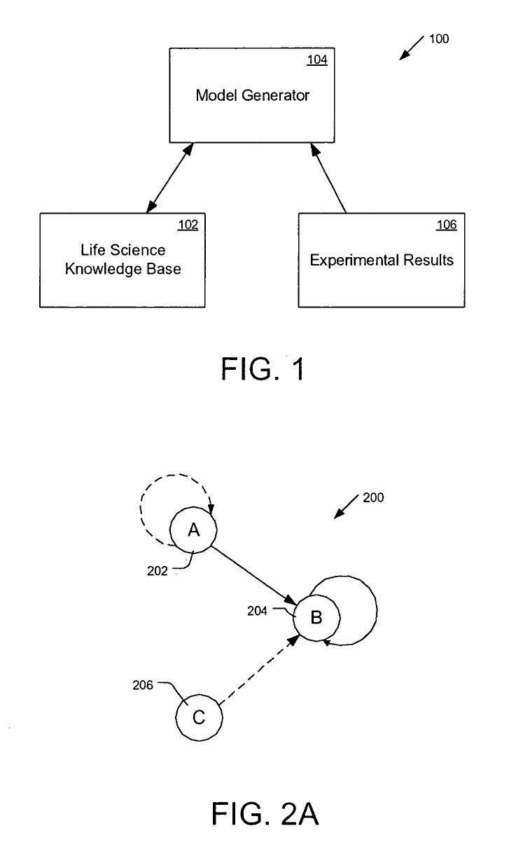

FIG. 1 is a block diagram showing an overview of an illustrative embodiment of the invention. An epistemic engine 100 includes a knowledge base 102, that stores representations of a wide variety of life sciences knowledge. In an illustrative embodiment, the knowledge is stored in the form of nodes, which represent life science objects, such as genes, molecules, cells, proteins, etc., and descriptors (which may also be referred to as case frames), which describe relationships between two (or more) nodes. Representation of life science knowledge as nodes and descriptors will be described in greater detail below.

The epistemic engine 100 also has a model generator 104, which generates models of biological systems, based in part on the knowledge stored in the knowledge base 102. The models produced by the model generator 104 attempt to expand on the knowledge present in the knowledge base 102 by creating models of biological systems that fit with existing knowledge from the knowledge base 102, and that explain experimental results 106 that are provided to the system. The experimental results 106 may include results reported in life science literature, laboratory results, patient data, patient studies, statistical data on populations, etc. In some embodiments, the models created by the model generator 104 may be added back into the knowledge base 102.

As will be described in detail below, in a preferred embodiment, the model generator 104 generates models using evolutionary algorithms, such as genetic algorithms or genetic programming. In general, models, which may initially be randomly generated, are evaluated by simulating the model to generate simulated data. The simulated data are compared to real data from the experimental results 106 and prior knowledge in the knowledge base 102. The closeness of the match between the real data and the simulated data and prior knowledge is used to determine a fitness score. In some embodiments, the fitness score may also be affected by the closeness of a match between the model, and known portions of the model (typically taken from the knowledge base 102 ).

As will be described in greater detail below, the models having the highest fitness scores are typically crossed with each other, using a crossover algorithm, and may be mutated to form the next generation of models. The evaluation, crossover, and mutation process is repeated for each generation, until a model is produced that has a high fitness, a predetermined number of generations have been generated, or the system settles over numerous generations on a single model.

The resulting model may provide a reasonable explanation of the experimental results, consistent with existing knowledge from the knowledge base 102. Having such a model may be useful in applications such as, for example, but not limited to, drug discovery, patient data analysis, clinical data analysis, medicinal chemistry, and other applications.

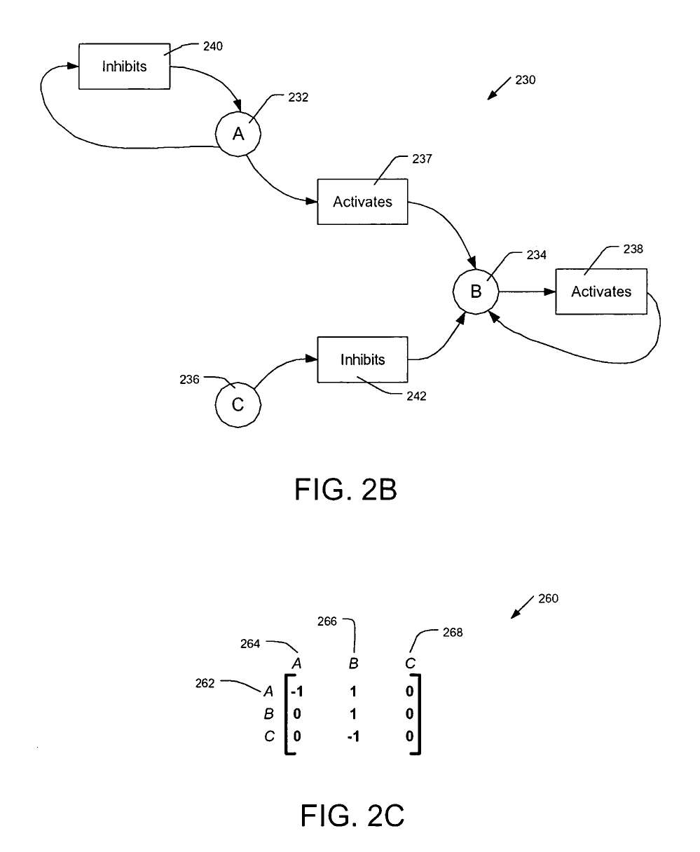

In accordance with an illustrative embodiment, the knowledge base contains life science knowledge represented by a set of nodes and descriptors (which may also be referred to as case frames). FIG. 2A shows an example gene regulation network 200. As can be seen, a gene A 202 inhibits the gene A 202, and activates the gene B 204. The gene B 204 induces activation of the gene B 204. The gene C 206 inhibits the gene B 204.

This type of gene regulation network may be represented by a set of nodes and descriptors, as shown in FIG. 2B. In FIG. 2B, a node 232 represents the gene A, a node 234 represents the gene B, and a node 236 represents the gene C. These nodes are connected to each other through descriptors. In this example, there are descriptors, such as descriptors 237, and 238, that represent an “activates” relationship between two nodes, and descriptors such as descriptors 240 and 242 that represent an “inhibits” relation.

Through use of nodes and descriptors, a directed graph 230 is able to represent the gene regulation network 200 of FIG. 2A. Nodes and descriptors, such as those shown in FIG. 2B may be used to represent many different types of life science knowledge. In general, descriptors represent relationships, such as “is activated by”, “is a cofactor of”, or other relationships between two (or possibly more) biological objects. Nodes represent the objects of these relationships.

Nodes may be, by way of non-limiting examples, biological molecules including proteins, small molecules, genes, ESTs, RNA, DNA, transcription factors, metabolites, ligands, trans-membrane proteins, transport molecules, sequestering molecules, regulatory molecules, hormones, cytokines, chemokines, histones, antibodies, structural molecules, metabolites, vitamins, toxins, nutrients, minerals, agonists, antagonists, ligands, or receptors. The nodes may be drug substances, drug candidate compounds, antisense molecules, RNA, RNAi, shRNA, dsRNA, or chemogenomic or chemoproteomic probes. Viewed from a chemistry perspective, the nodes may be protons, gas molecules, small organic molecules, amino acids, peptides, protein domains, proteins, glycoproteins, nucleotides, oligonucleotides, polysaccharides, lipids or glycolipids. Proceeding to higher order models, the nodes may be protein complexes, protein-nucleotide complexes such as ribosomes, cell compartments, organelles, or membranes. From a structural perspective, they may be various nanostructures such as filaments, intracellular lipid bilayers, cell membranes, lipid rafts, cell adhesion molecules, tissue barriers and semipermeable membranes, collagen structures, mineralized structures, or connective tissues. At still higher orders, the nodes are cells, tissues, organs or other anatomical structures, for example, in a model of the immune system, which might includes immunoglobulins, cytokines, various leucocytes, bone marrow, thymus, lymph nodes, and spleen. In simulating clinical trials the nodes may be, for example, individuals, their clinical prognosis or presenting symptoms, drugs, drug dosage levels, and clinical end points. In simulating epidemiology, the nodes may be, for example, individuals, their symptoms, physiological or health characteristics, their exposure to environmental factors, substances they ingest, and disease diagnoses.

Descriptors are the types of biological relationships between nodes and include, but are not limited to, non-covalent binding, adherence, covalent modification, multimolecular interactions (complexes), cleavage of a covalent bond, conversion, transport, change in state, catalysis, activation, stimulation, agonism, antagonism, up regulation, repression, inhibition, down regulation, expression, post-transcriptional modification, post-translational modification, internalization, degradation, control, regulation, chemoattraction, phosphorylation, acetylation, dephosphorylation, deacetylation.

In an illustrative embodiment of the invention, a directed graph, such as the directed graph 230, which uses nodes and descriptors to represent complex interrelations in the life sciences, may be further represented by a vector, matrix, multi-dimensional array, or other structured representation that may be readily generated or manipulated by a computer.

FIG. 2C shows the same set of interrelations that are shown in the directed graph 230, represented as a matrix 260. Each of the rows of the matrix 260 represents a node, as does each column of the matrix 260. The values in the matrix 260 represent the descriptors that describe the relationships between the nodes. In this example, a value of “1” indicates an activation relationship, a value of “−1” indicates an inhibition relationship, and a “0” indicates no relationship.

Thus, the first row 262 of the matrix 260, which represents the gene A has the value “−1” in the column 264 (that also represents gene A), indicating that gene A inhibits gene A. The first row 262 includes a value of “1” in the column 266, which represents gene B, indicating that gene A activates gene B. The first row 262 includes a value of “0” in the column 268, which represents gene C, indicating that gene A neither activates nor inhibits gene C.

Any of the knowledge or information that can be represented by a directed graph of nodes and descriptors, such as the directed graph 230 of FIG. 2B could be represented in a matrix, such as the matrix 260 of FIG. 2C. Generally, the nodes are represented along the rows and columns, and the descriptors are represented as the values in the matrix. For each different type of descriptor used, a different value may appear in the row and colurn corresponding to a pair of nodes that are related by that descriptor. Since nodes and descriptors, as discussed above, can be used to represent most any life science knowledge, similarly, a matrix, such as the matrix 260 may be used to represent most any life science knowledge.

In some embodiments, in which quantitative information, such as reaction rates, fold change values, etc., is represented, the matrix may contain both indications of the descriptor type, and quantitative values. Alternatively, the quantitative values may be represented in a separate value matrix, parallel to the matrix of descriptor information, in which each entry in the value matrix corresponds to a descriptor in the matrix of descriptor information. In some embodiments, instead of associating values with the entries in the matrix, each entry in the matrix of descriptors may be associated with an equation or differential equation, defining a quantitative property of the relationship represented by the descriptor.

In some embodiments, each entry in the matrix of descriptor information, such as the matrix 260, may be associated with a confidence value, representing the degree of confidence that is to be placed in the relationship that is defined by the entry. For example, the scientific data supporting the existence of some relationships may be reasonably solid, justifying a high confidence value, whereas in other cases, the scientific data may be slight or conflicting, justifying only a low confidence value. These confidence values may be enhanced or reduced within the epistemic engine, as will be described below. As with quantitative information, in some embodiments, the confidence values may be kept in a separate confidence matrix, parallel to the matrix of descriptor information.

It should be understood that a matrix representation, such as is shown in FIG. 2C is only one way in which the network or web of relationships conveyed by a directed graph of nodes and descriptors may be represented in a computer. The information could instead be represented as a vector, a multi-dimensional array, a linked data structure, or many other suitable data structures or representations.

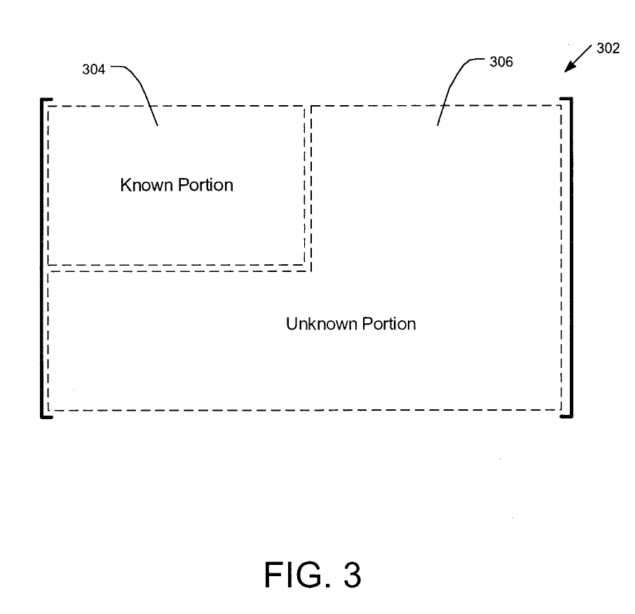

FIG. 3 shows a matrix of descriptor information, similar to the matrix 260 of FIG. 2C, in which both known and unknown life science information are represented. In some embodiments, the epistemic engine 100 may operate on both known and unknown information in order to determine suitable models for the unknown information. To operate on this information, a matrix is created, representing both known and unknown portions of a web or network of relationships that the epistemic engine 100 is to generate.

For example, in FIG. 3, the known portion 304 of the matrix 302 may represent known information about the biological pathways involved in cancer, in general. The rows and columns in this portion of the matrix may be gene expression information on genes known to be associated with cancer. The unknown portion 306 of the matrix 302 may represent, for example, unknown information specific to a particular type of cancer, such as breast cancer. In this example, the rows and columns of the unknown portion 306 may represent genes that are thought to be involved in breast cancer, but for which all of the pathways and connections are not known.

The job of the epistemic engine 100 will be to fill in the unknown portion 306 of the matrix 302 with a set of connections between elements that fits with the known portion 304, and with experimental data and other life science knowledge. Generally, the known portion 304 will be excluded from the process of generating models (which will be described in greater detail below), but will be used when models are evaluated. In some embodiments, where confidence values are associated with each element of the matrix 302, the epistemic engine may be able to increase or decrease the confidence values associated with elements in the known portion 304. If the confidence value of an element in the known portion 304 falls below a predetermined threshold, the element may be treated as being effectively unknown, and may changed during the process of generating models.

Advantageously, by including known information, such as is represented in the known portion 304 of the matrix 302, the amount of material in the matrix 302 that must be generated by the epistemic engine may be dramatically reduced. This may allow the epistemic engine to converge on an acceptable model to fill in the unknown portion 306 of the matrix 302 much more rapidly than if the entire matrix 302 had to be derived. Additionally, the known portion 304 of the matrix 302 may assist in evaluating possible models. Further, once a model is generated that adequately explains experimental information, and fills in the values of the unknown portion 306, the presence of the known portion 304 may be used to automatically tie the newly derived information into the rest of a knowledge base of biological information.

In some embodiments, or for some models that are to be generated, there may be little or no known information. In these cases, the known portion 304 may be omitted from the matrix 302.

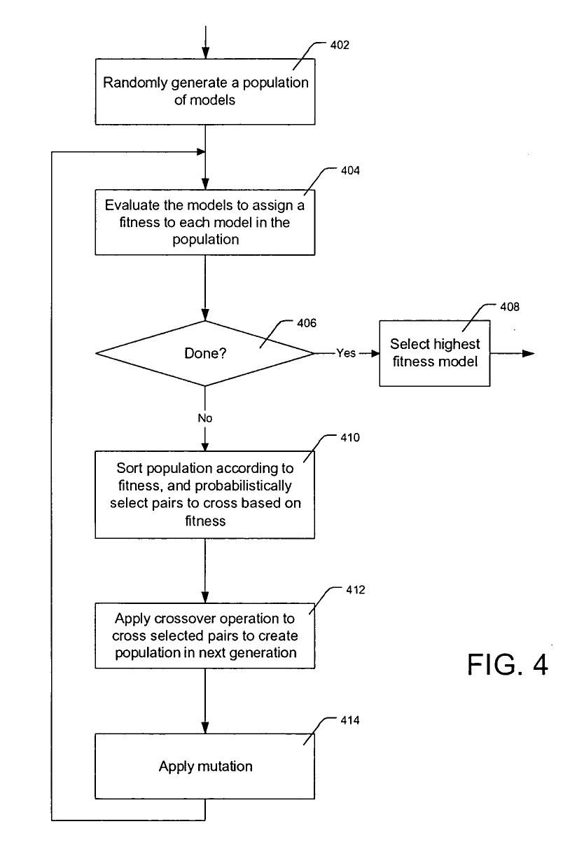

FIG. 4 shows a flowchart of the operation of the model generator 104 according to an illustrative embodiment of the invention. In this illustrative embodiment, the model generator 104 uses a matrix, such as is shown in FIG. 2C and FIG. 3 to represent knowledge and models. The illustrative embodiment derives models using genetic algorithm techniques. Existing software packages, such as the GAlib genetic algorithm package, written by Matthew Wall at the Massachusetts Institute of Technology, may be used to implement genetic algorithm techniques.

It will be understood that other representations could be used by the model generator, and other techniques may be used for deriving a model. For example, most any evolutionary algorithm-based technique may be used to derive models, including genetic algorithms, genetic programming, genetic algorithms combined with fuzzy logic or neural networks, or other known genetic or evolutionary algorithm techniques. In general, the model generator 104 derives a model that explains experimental results and that fits with prior life science knowledge through a process of conjecture and refutation.

In step 402, the model generator randomly creates numerous possible models to create a “population” of models. In an illustrative embodiment that uses a matrix representation, such as is described above, this may be done by creating numerous matrices of the appropriate dimensions, and populating the unknown portions of those matrices with randomly generated values. The known portions of the matrices, if present, may be copied from the known information, and are not subject to random generation. Quantitative values associated with the initial population may also be randomly generated, if they are being used.

In some embodiments, rather than copying the known portions of the matrices, the entries in the known portions may be randomly generated, but may be penalized by the evaluation function if they do not match entries in the known portion that have a high confidence value. This permits the known portion to be changed over time, since a model that scores a high fitness value, despite the penalties for not matching the entries in the known portion, may be used to challenge the validity of the known portion (e.g., by lowering the confidence values) of the matrices that represent the models.

Each of the matrices generated represents a randomly generated proposed electronic biological model that specifies pairs of nodes (the rows and columns), and descriptors (the values in the matrix) that interrelate the nodes. While most or all of the randomly generated matrices may not represent a network or web of biological information that corresponds to any real-world system, they may serve as a starting point for the application of evolutionary algorithms, which may steadily improves the results.

In step 404, an evaluation function is applied to the population of models, to assign a “fitness” to each of the models in the population of models. According to an illustrative embodiment of the invention, this evaluation function simulates each of the models, to generate simulated resulting data. If quantitative data is being used, the quantitative data is taken into account during the simulation. If quantitative data is not being used, then the simulation is based solely on qualitative information present in the nodes and descriptors, and is performed using qualitative simulation techniques. Qualitative simulation techniques are techniques known in the art that have been developed to enable modeling at a higher level of abstraction than that of quantitative simulation alone.

The simulated resulting data are then compared to real data. Such real data may, for example, be the result of performing experiments in a laboratory, compiling statistical studies of a population, carrying out studies on patients, or other sources of life-science data or observations. Real data may be collected by performing experiments or studies, or by compiling information and knowledge on experiments and studies from life science literature.

Fitness values are determined according to how closely the simulated data from the model corresponds to the real data. For models where the simulated data and the real data closely correspond, the fitness value will be high. For models where there is little or no correspondence between the real data and the simulated data, the fitness value will be low.

In some embodiments, in which confidence values are associated with entries in the matrix that represents the model, the fitness of a model may be penalized if the model contradicts entries that have a high confidence value. As noted above, this may be used to challenge the “known” portions of a model, if the fitness is high despite these penalties.

If any model having an extremely high fitness, such as being a perfect or near perfect match for the real data has emerged, or a predetermined number of generations have been run, or any other criteria for determining when the model generator 104 is done with its task apply (step 406), then the model generator 104 may choose the most fit model as the best model to explain the real data (step 408). In some embodiments, the criteria for ending the generation and evaluation of new models may be varied. For example, in some embodiments, the system may stop only once a predetermined fitness value is achieved, or once a predetermined fitness level is achieved in a predetermined portion of the population. In some embodiments, the system may stop after a predetermined number of generations, but only if a particular fitness has been reached. In some embodiments, the system may continue until a stable state has been reached, in which the same model continues to dominate the fitness values for numerous generations, despite crossover and mutations. Other known criteria used by genetic algorithms may also be used to determine when the model generator 104 should stop generating and evaluating new models.

Next, in step 410, the model generator 104 sorts the models according to their fitness values, and probabilistically chooses fit pairs to cross and mutate to generate a population of models for the next generation. Models with low fitness values are very unlikely to be chosen for crossing with other models, and are unlikely to contribute to the next generation of models, whereas models with high fitness values are very likely to be crossed with other models to generate the next generation of models.

In step 412, the model generator 104 crosses the fit pairs that were chosen in step 410. In an illustrative embodiment, this may be done by transforming the unknown portions of the two matrices to be crossed into two vectors, randomly selecting a point in the vectors at which the crossover will occur, and then swapping the information in the two vectors that occurs after the selected crossover point. The two vectors may then transformed back into the unknown portions of matrices representing models. These newly generated models are then mutated (as described below), and added to the next generation population of models. In some embodiments, the entire matrix, including known portions, or known portions for which the confidence value is low may be included in the crossover process.

In some embodiments, the most fit members of a population are directly copied into the next generation population of models, without undergoing crossover or mutation. In some embodiments, a fixed crossover point may be used, rather than a randomly generated crossover point. In some embodiments, other known crossover techniques, such as multi-point crossover techniques, or partially matched crossover techniques, that are used in genetic algorithms may be employed.

Next, in step 414, the model generator 104 applies mutations to models that have resulted from the crossover of step 412. In an illustrative embodiment, a mutation may occur at random, with a relatively low probability. If a mutation does occur, it may cause a random change in a randomly selected position in a matrix that represents a model. These mutations may prevent the system form settling into a local maximum (which may not be as good as other local maxima, or as good as the global maximum) in the fitness space, by providing a way to randomly escape such local maximums.

In some embodiments, burst mutation, in which occasional high bursts of mutation occur and then reduce over a number of generations, may be used. In some embodiments, the mutation rate may be kept at a constant level. Other known mutation strategies known in the art that are used in genetic algorithms, such as simulated annealing, may also be used.

Once mutations have been applied, a new population (i.e., a new generation) of models are available for evaluation. The model generator repeats steps 404 through 414 on the new generation of models, to create another generation, and so on. The process is repeated until the criteria discussed above with reference to step 406 have been met. In some embodiments, the model generator runs continuously, constantly improving the fitness of the population of models, and immediately responding if, for example, the known portion of the model changes, or the real data (e.g. from experiments or studies) changes. In general, the model generator 104 searches a fitness space using evolutionary algorithm techniques to find models with high fitness.

A model having a high fitness value may be used to explain the real experimental results that have been observed in terms of the underlying web of biological relationships that cause the observed results. This is because the model produced by the model generator represents a set of nodes and descriptors, which represent a web of biological relations. Nodes and descriptors that result from models generated by the model generator may be linked into a knowledge base of life science knowledge, where they may be used for generation of other models.

In some embodiments, descriptors in a model generated by the model generator may be assigned a confidence value. In some embodiments, this confidence value may be increased as the descriptors tie into other models, or as other indications of their reliability are discovered. Confidence values may be decreased when better (i.e., higher fitness) models are produced without the particular descriptor. Confidence values relating to known information in a model may also be affected, if it is found that models in which the “known” portion of the model is changed provide results that are a better match with the experimental results.

It should be noted that the epistemic engine 100, including the model generator 104 may be applied to numerous different tasks simultaneously. These various models may be unrelated, involving completely different sets of life science knowledge. These seemingly unrelated models may be connected when the models are put into a knowledge base that contains connections that create relations between the nodes that are used in the models. In some instances, multiple models that are being processed may be related because they share some nodes or pairs of nodes related by a descriptor, or because the known or unknown portions of the models have some overlap.

In some instances, real data (e.g., from experiments or patient studies) may not be completely consistent. In these instances, it is possible that two or more contradictory models, all with relatively high fitness scores, may arise. In such cases, it may be useful to permit the multiple contradictory models to co-exist, and to continue to develop alongside each other. Segmentation techniques that may be used with genetic algorithms may also be used to provide this capability. In general, the system determines when multiple models with high fitness scores are sufficiently different or contradictory that they should be segmented into two or more separate sets of models to explain the same real data. Once the models have been segmented, they continue to evolve separately, leading to two or more different models that fit the same set of real data and knowledge.

It should be understood that the presence of such multiple contradictory models is both acceptable and expected. In many instances, when working with systems as complex as those encountered in the life sciences, it is not practical to develop a single model that, for example, describes a disease.

When multiple contradictory models are present, the contradictory models can be overlaid by the system, to determine which portions of the models are common (or at least similar), and which are contradictory. Where there are contradictory regions, it may be possible to do experiments to disambiguate the models, or to determine which of the models is closer to explaining the actual biological processes. Thus, contradictory models may have particular value in the epistemic engine 100, since they may suggest experiments that would be useful to perform.

In some embodiments, the functionality of the systems and methods described above may be implemented as software on a general purpose computer. In such an embodiment, the program may be written in any one of a number of high-level languages, such as FORTRAN, PASCAL, C, C++, LISP, JAVA, or BASIC. Further, the program may be written in a script, macro, or functionality embedded in commercially available software, such as EXCEL or VISUAL BASIC. Additionally, the software could be implemented in an assembly language directed to a microprocessor resident on a computer. For example, the software could be implemented in Intel 80×86 assembly language if it were configured to run on an IBM PC or PC clone. The software may be embedded on an article of manufacture including, but not limited to, a “computer-readable medium” such as a floppy disk, a hard disk, an optical disk, a magnetic tape, a PROM, an EPROM, or CD-ROM.

An example application of an embodiment of the invention, used to determine gene regulatory networks in sea urchin development, is described in detail below. The gene regulatory network produced in this example embodiment validates the system and methods of the invention, by producing a gene regulatory network that matched known gene regulatory networks in sea urchin development, and that included additional paths, the existence of which had been noted or conjectured by researchers.

Data relating to gene regulation of purple sea urchin (Strongylocentrotus purpuratus) embryo development has been made publicly available by the Davidson Laboratory of the California Institute of Technology on the Internet at: http://its.caltech.edu/˜mirsky/qpcr.html. Table 1 below is a sample of the data giving the effects on two transcription factors out of a total of 60 genes. The data set relates to experiments performed at the Davidson Laboratory that involved quantitative PCR studies on embryos during the early stages of development (i.e., less than 72 hours). The portion of the data in Table 1 relates to the pertubation of multiple genes and the effects on the transcription factors, GataC and GataE. Details of the findings from the studies have been published in Davidson et al., A Genmoic Regulatory Network for Development, Science 295, 1669-78 (2002).

TABLE I

| Gene | Perturbation | 12-16 hr | 18-21 hr | 24-27 hr | 30-36 hr | 41-48 hr | 60-72 hr | Data of: |
|---|---|---|---|---|---|---|---|---|
| gatac | Cad MOE | | −2.4/NS | −6.4/−3.6/ | | | | A Ransick |
| | | | | −4.9 | | | | T. Minokawa |
| | | | | | | | | & C. Livi |
| | Elk-En | | | −6.0, −5.2, | | | | M. Arnone |
| | | | | −5.7 | | | | |
| | Otx-En | | | −2.1/−3.3 | | | | A Ransick & |
| | | | | | | | | T. Minokawa |
| | GataE MASO | | NS/NS/N | −2.2, | | | | P.Y. Lee |
| | | | S/NS/NS | −2.5/NS, | | | | |
| | | | | NS/−2.4, | | | | |
| | | | | −2.5 | | | | |
| | Dri MASO | | −2.1/−2.3 | | NS/NS | | | G. Amore |
| | N MASO | | −2.6 | | NS (29 h) | NS | | C. Calestani |
| | GataC MASO | | | +3.1, | | | | P. Oliveri |
| | | | | +3.7/NS | | | | |
| | Hnf6 MASO | | −2.5/−3.0 | | | | | G. Amore & |
| | | | | | | | | O. Otim |
| | Gem MASO | | −2.2 | −2.5 | | | | A. Ransick |
| gatae | Cad MOE | NS/NS | −5.1/−3.1 | −4.7/−3.6/ | | | | A. Ransick |
| | | | | −3.1 | | | | T. Minokawa |
| | | | | | | | | & C. Livi |
| | DnN MOE | | −2.4/−1.4 | | | | | C. Calestani |
| | Otx-En | | −3.3, −2.2/ | NS/−1.5, | | | | A. Ranisck & |
| | | | −2.8, −3.0/ | −2.4/−2.4/ | | | | T. Minokawa |
| | | | −3.2 | −4.1/−2.4 | | | | |
| | Hox11/13b | +1.6 | | +2.4/+1.7 | | | | C. Arenas- |
| | MASO | | | | | | | Mena |
| | Soxb1 MOE | −1.7, −3.2/ | | | | | | J. Rast & |
| | | −2.0, −2.1 | | | | | | K. Young |
| | KrI MASO | | −2.1/NS, | NS, NS/ | | | | J. Rast & |
| | | | −2.0/−2.6, | +4.4, +2.2 | | | | K. Young |
| | | | −3.7 | | | | | |
| | FoxA MASO | | | | | −2.8, −1.6 | | K. Young & |
| | | | | | | | | P. Oliveri |
| | Hox11/13b | | | +2.4/+1.7 | | NS | NS | C. Arenas- |
| | MASO | | | | | | | Mena |
| | Hnf6 MASO | | | | NS/NS | −2.1/−2.6 | | G. Amore & |
| | | | | | | | | O. Otim |

The experiments performed on the sea urchin embryos involved perturbation of genes and measurement of changes in expression of a second target gene. In the absence of other influences, perturbation of a gene that is an activator of another will cause the expression of the second gene to be decreased. Alternatively, if the perturbed gene is inhibitory, the expression level of the latter will be increased.

The numerical values refer to the cycle number in the PCR experiment and this relates back to the starting level of mRNA, which is amplified exponentially during PCR. A value of 1 represents an approximate doubling of initial mRNA level. Thus, if a value of 3 is reported for an interaction, perturbation of the gene resulted in an 8 fold increase in the gene product compared with the unchanged cell. The convention used in the data is that negative values mean less starting mRNA. Thus, if perturbation of a gene results in lower quantities of mRNA transcribed from target genes, the relationship must have been activation. Similarly, positive values indicate inhibition.

Transcription regulation involves a complex network of genes that encode transcription factors which, in turn, regulate other genes. A specific transcription factor can regulate multiple genes and there are chains of interactions which form a cascade. Thus, perturbation of a single gene can affect the expression of many other genes both directly and indirectly. Consequently, an observed change in gene expression is the result of the combined effects on all of the regulatory genes that influence its transcription. Being able to determine whether an interaction is direct or indirect is a hurdle in deciphering causality in gene regulatory networks.

The Davidson Laboratory presented data relating to three types of perturbations: (1) Morpholino-subsituted antisense oligonucleotide (MASO), where the mRNA transcribed from a gene binds to the complimentary RNA strand, thereby preventing translation of the gene product; (2) Messenger RNA overexpression (MOE), which involves amplification of gene products from the perturbed gene; and (3) Engrailed repressor domain fusion (En), where the transcription factor is converted into a form in which it becomes the dominant repressor of all target genes.

These three techniques represent distinctly different methods for gene perturbation. However, no distinction between techniques was made, results having been taken as being equivalent, and data for the same perturbation, but from different experimental techniques, were combined. The results for each perturbation experiment were reported as up to 7 individual values that relate to both replicate measurements of the same cDNA batch and separate experiments. These values were averaged to provide a single value for equivalent samples. Results recorded as Not Significant (NS) were treated as zero.

In addition to gene perturbation results, the Davidson Laboratory published a table of genes that are not affected by perturbation during the first 24 hours, and the table included footnotes that have information about gene interactions, many of which highlight possible indirect effects. This additional information was incorporated into the experimental data to yield a single value for the effect of one gene on another. Data were available for only around 12.8% (460 out of 3600) of the possible interactions. For the purpose of this analysis, the unknown interactions were taken to indicate no interaction unless there were indications to the contrary.

The overall data set contained 60 genes identified to regulate gene expression in sea urchin embryos. To simplify the system, a decision to concentrate on the endomesoderm was made since there was the greatest quantity of data relating to these cells. The remainder of the embryonic regions had considerably less experimental coverage. Twenty-one regulatory genes are active in the sea urchin endomesoderm during the chosen developmental stages and, of the 441 possible interactions, there are 162 data points or 36.7% coverage.

In addition to the 21 genes, the published endomesoderm regulatory network also includes complexes (e.g., Su(H)—N^{IC}, n-TCF) involving endomesoderm gene products. However, no data were presented that supported the formation of these complexes, nor was there any data for their action within the cell. Therefore, complexes were omitted from the analysis.

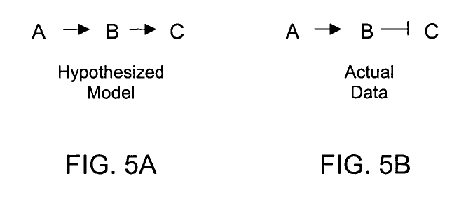

The algorithm used is based on exploring the state space of all possible gene networks (models) using a genetic algorithm. The first step involves randomly generating hundreds of models from a given set of components. The components for the gene network are an activation, an inhibition, and no effect. These three relations between genes are represented as +1, −1 and 0 in a matrix of gene-to-gene interactions. The initial model generated represents a hypothesis that has to be tested and scored. The next step involves simulation. The models, which represents a set of regulatory connections between genes, can be simulated qualitatively. For example, as depicted in FIG. 5A, the network (i.e., hypothesized model) contains the following relation: A activates B which activates C. Experimental data are checked to see what experiments have been done. Assume that one of the experiments involved overexpressing A then, according to our hypothesized model, an overactivation of A will result in an increase in B and C. The results of the simulation are tested against the actual data. As indicated in FIG. 5B, the actual data will show that B increases and C decreases. This comparison is then used to score the models. New models are generated through a combination algorithm, such as crossover, to create a new population of models. Standard genetic algorithm techniques known in the art such as mutation, probabilistic selection, and combination may be used to create new models. The models are then simulated, evaluated, and scored. The process is followed iteratively until the score does not improve any more. To avoid local minima, the modified models are randomly perturbed using an annealing method.

The technique used for scoring gene regulatory networks was done by simulating the experimental conditions. For example, if an experiment involved over-expression of a gene, then the algorithm finds the gene in a model and follows all outgoing activation and inhibition links. This is done several steps out and predictions are made of all the intervening genes whether they are expected to go up or down. These predictions are compared to the actual data. For every correct prediction a score of “+1” is assigned and a “−1” for every wrong prediction. A prediction that something will not change is also compared to the actual data and scored for correctness. This process is applied to all experiments and all models to generate a matrix of scores. The scores are used to drive the genetic algorithm.

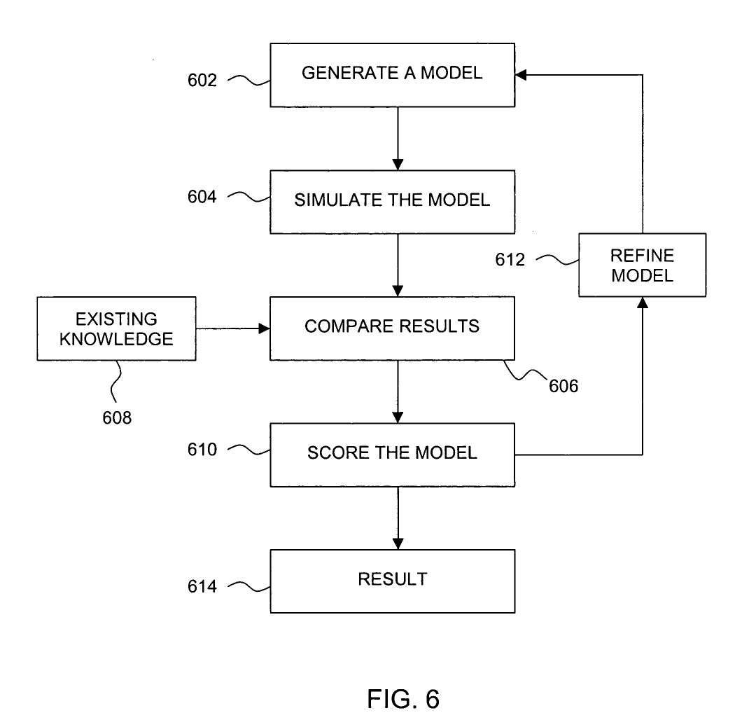

FIG. 6 shows a molecular epistemics algorithm of conjecture and refutation for use in exemplification of the present example. In step 602, a model or hypothesis is generated. In step 604, the model or hypothesis is simulated. In step 606, results from the simulation are compared to existing knowledge 608, which includes, but is not limited to, experimental data and footnotes from scientific articles. In step 610, the model or hypothesis is scored. In step 612, the model or hypothesis is refined, and the molecular epistemics algorithm is started again at step 602. In step 614, results are obtained with the model or hypothesis being selected.

The process of scientific discovery involves experimentation, but interpretation of the results involves bringing to bear ones prior knowledge of the underlying biology. The present invention allows for outside literature, footnotes and personal knowledge to be added to the model before it runs. This is achieved in two ways. The first approach is to incorporate externally known regulatory knowledge into the input data prior to running the algorithm. Another approach involves incorporating known prior knowledge into the initial model. The rationale here is to make some of the gene-to-gene connections “fixed” or pre-set before the model generation process is started. If this cannot be done for all the knowledge, it can be incorporated into the scoring algorithm.

Networks generated by the algorithm in the present example were displayed graphically using Netbuilder, a tool for construction of computation models developed by Science and Technology Research Centre, University of Hertfordshire, United Kingdom. This tool was also used by the Davidson Laboratory team to display their network results. The overall network layout presented used here was chosen to closely resemble the overall network layout used in the Davidson paper to make for easier comparison.

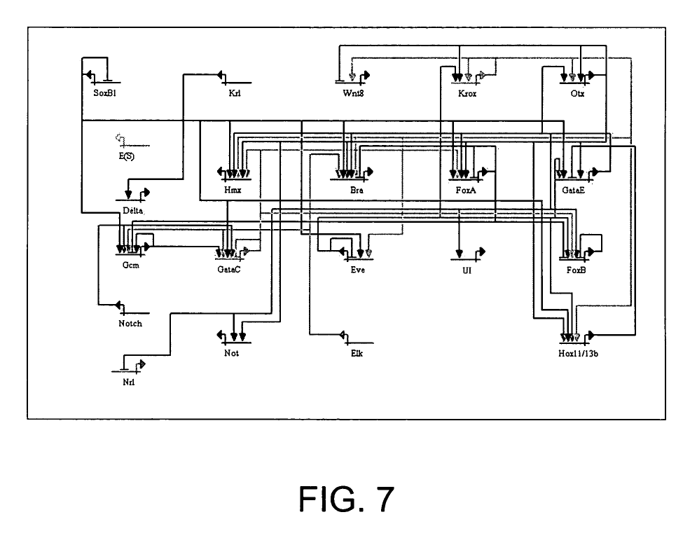

By using a straight substitution of the data with values greater than or equal to the threshold taken to mean activation or inhibition depending on the sign, and all other values to signify no connection, a simple representation of the entire network of connections was obtained, as shown in FIG. 7. FIG. 7 shows an automatically-generated, endomesoderm gene regulatory network that directly reflects the raw data of the Davidson Laboratory. This interpretation takes into account the additional information provided in the footnotes to the data (incorporated into the values), but is doing no interpretation or analysis of the data. The generated network comprises 56 links between the genes of which 45 were activations and 11 inhibitions.

The complete network generated directly from the data is similar to the endomesoderm network published by the Davidson Laboratory, however there are some notable differences which may not be related directly to interpretation of the information. First, the data available on the Davidson Laboratory's Internet web site is constantly under review and is augmented as new results become available. The data set used in the present example was dated Oct. 28, 2002, and was considerably newer than that used to construct the network that was published in Davidson et al., A Genmoic Regulatory Network for Development, Science 295, 1669-78 (2002). Second, the Davidson Laboratory's network represents the regulatory network for the organism and includes many genes that are not active in the endomesoderm. These genes will have interactions with the 21 genes under study which may have effects that are not apparent when the endomesoderm is viewed in isolation.

Nevertheless, there are still discrepancies. Some links are present on the published network even though the data set indicates that they should not be there. For instance, there are data to suggest an activation link between bra and nrl, however, a footnote states that this must be an indirect link since bra is not active in the cell at this time. The data used for this work took all of the footnotes into account and does not show this link, whereas the published network included it. On the other hand, there is data to support an activation link between eve and four other genes, yet the published networks only show a single effect. Thus, while these networks and the Davidson Laboratory published networks show similar information, they show some differences which are, at least partly, due to differences in the source data.

The scoring mechanism in the underlying algorithm was modified to give a low score to links that can be explained by intermediate genes. This serves to downplay models that have redundant links, and also to remove indirect links, thereby generating a minimal network that explained the raw data faithfully. For instance, elk, Soxβ1 and Notch all activate both GataC and gcm, and gcm activates GataC, as shown in FIG. 7. Therefore, it is possible that the observed effects on GataC were really a result of an indirect effect through gcm. This suggests that the three links from elk, Soxβ1 and Notch to GataC could be removed without contradicting information contained in the data.

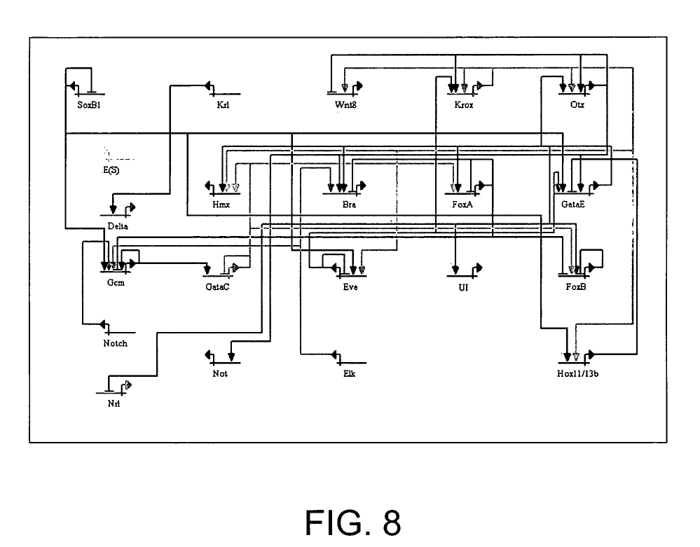

By eliminating the maximum number of links without breaking any of the connections between genes or making a link with too many intermediates, it was possible to remove 13 links from the network (all activations) and reduce the total number of links from 56 to 43, as shown in FIG. 8. FIG. 8 shows an automatically-generated, minimal Endomesoderm network with links removed where a connections is already present through a single intermediate node. On the complete network, genes highlighted in rectangular boxes have links to both GataC and gcm (as shown by the ellipses). In the minimal network, their actions on GataC are all through gcm. In separate runs of the algorithm it was possible to get slightly different sets of links removed, but the minimum number of links necessary to explain all of the data was still 43.

The algorithm was also run in a configuration that permitted the removal of links that can be explained through pathways of up to two intermediate genes. In this way, three extra edges could be removed, however the more intermediates there are the harder it is to justify that the link has been retained and the observed effect is still valid.

Data for the 21 endomesoderm genes at each time period was rendered into a separate network to compare expression profiles at each time. This yielded a set of networks that contained 15 (12-16 hours), 30 (18-21 hours), 45 (24-28 hours), 6 (32-36 hours), 2 (40-48 hours) and 0 (60-72 hours) links. Although gene expression does change through the development stages, it is unlikely that these results represent an accurate picture of the regulatory system, rather an indication that the dataset is incomplete. Thus, without additional data to indicate that genes operational at one period are turned off in another (there are some data), it will be very difficult to draw any conclusions from these observations.

The approach used for the present example relied on definitive assignment of a link (or no link) between two genes based on the data. The output from the algorithm is trinary, and therefore, relies heavily on the thresholding function to define whether a gene is activated or inhibited. There is no indication as to the certainty of these predictions and this “all-or-nothing” approach leads to the possibility that a small change in the threshold level can create or eliminate links.

The rationale here is to generate networks with links with varying levels of confidence. This may be accomplished by the present invention by placing link values on a continuous scale, for example from −10 to +10. The output value is a measure of the certainty that the algorithm can predict the presence of a link. For instance, a value of −10 would mean an activation relationship with absolute certainty, likewise +10 for a certain inhibition. A value closer to zero is less certain. A threshold function will still be required to apply the cut-off that defines an interaction with no link. Nevertheless, a value just exceeding the threshold will be labeled as uncertain, rather than all links having equal validity.

A mechanism for incorporating external auxiliary knowledge of biology is needed in the art. The present invention attempts to solve this need. An example of where auxiliary information could be used is in the action of Otx on wnt8. The data indicates that this should be a straight forward inhibition. However, the published network indicates that Otx activates an intermediate gene labeled “Rep. of wnt8” [Repressor] and that this gene inhibits wnt8. There is no footnote with the data that could indicate why the link was drawn like this, yet evidence can be found in Davidson et al., A Provisional Regulatory Gene Network For Specification of Endomesoderm in the Sea Urchin Embryo, Developmental Biology 246, 162-190 (2002). This paper reported that introduction of an obligate repressor of Otx target genes resulted in a many fold increase in the transcripts of wnt8. Thus, this information is showing that the action of otx on wnt8 is a two (or more) step process. This knowledge could have been incorporated into the algorithm to improve accuracy of the output.

The present invention could utilize the auxiliary information known about interactions and incorporate this into the decisions to include a link or not. Thus, additional knowledge could be used to strengthen the case for a particular configuration of the network over another. Automated generation of biopathways can help generate large complex gene regulatory networks that can be minimized to best explain the raw data. These methods can incorporate knowledge gleaned from the literature, footnotes and other sources. This makes the approach closer to how a human would work—bringing together knowledge and prior experiences when interpreting results from experiments.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A method of proposing new genomic/proteomic-related knowledge, the method comprising the steps of:
a) providing a representation structure for genomic/proteomic-related concepts comprising
i) nodes representative of known genomic/proteomic information selected from the group consisting of, conditions, processes, and physical structures, and
ii) qualitative descriptors representative of interrelationships among nodes;
b) proposing a biological model using said representation structure and specifying plural pairs of nodes and descriptors between selected nodes from said representation structure;
c) simulating the proposed biological model to produce simulated data;
d) assigning a fitness measure to the proposed biological model as a measure of how the simulated data compares to said data representative of measured biological behavior or properties;
e) repeating steps b) through d) for a plurality of different proposed biological models; and
f) selecting one of said different proposed biological models in response to the fitness measures of said plurality of biological models.

2. The method of claim 1, wherein said biological model is proposed using an evolutionary algorithm.

3. The method of claim 1, wherein said biological model is proposed using genetic programming or a genetic algorithm.

4. The method of claim 1, wherein said biological model comprises a population of biological models.

5. The method of claim 1, wherein said method comprises an additional step of proposing new biological models using models simulated and scored in step d) by applying genetic algorithm crossover techniques.

6. The method of claim 5, wherein said genetic algorithm crossover techniques comprise mutation or probabilistic selection.

7. The method of claim 1, wherein said proposed biological model includes nodes of established position interconnected by established descriptors.

8. The method of claim 1, wherein said representation structure further comprises differential equations quantitatively representing possible relationship between pairs of nodes.

9. The method of claim 1, wherein qualitative simulation techniques are used to simulate the proposed model to produce simulated data.

10. The method of claim 1, comprising repeating said method using datasets probing disparate biological subsystems or substructures and combining models of said disparate subsystems or substructures into a consolidated model.

11. The method of claim 1, comprising repeating said method using datasets probing networks within a physiological pathway, cell compartment, cell, organism, population, or ecological system to discover subsystem networks, and combining disparate subsystem networks into a consolidated network.

12. The method of claim 1, wherein said nodes comprise enzymes, cofactors, enzyme substrates, enzyme inhibitors, DNAs, RNAs, transcription regulators, DNA activators, DNA repressors, signaling molecules, trans membrane molecules, transport molecules, sequestering molecules, regulatory molecules, hormones, cytokines, chemokines, antibodies, structural molecules, metabolites, vitamins, toxins, nutrients, minerals, agonists, antagonists, ligands, receptors, or combinations thereof.

13. The method of claim 1, wherein said nodes comprise protons, gas molecules, small organic molecules, amino acids, peptides, protein domains, proteins, glycoproteins, nucleotides, oligonucleotides, polysaccharides, lipids, glycolipids, or combinations thereof.

14. The method of claim 1, wherein said nodes comprise protein complexes, protein-nucleotide complexes, cell compartments, organelles, membranes, or combinations thereof.

15. The method of claim 1 wherein said nodes comprise descriptors or networks of nodes and descriptors comprising a substructure or sub-network of a biological system.

16. The method of claim 1, wherein said nodes comprise cells, tissues, or organs.

17. The method of claim 1, wherein said nodes comprise drug candidate molecules.

18. The method of claim 1, wherein said nodes are individuals of a species.

19. The method of claim 1, wherein said data representative of measured biological behavior or properties comprises data representative of experimental data, knowledge from the literature, patient data, clinical trial data, compliance data; chemical data, medical data, or hypothesized data.

20. The method of claim 1, wherein said data representative of measured biological behavior or properties comprises data acquired using PCR, qualitative PCR, gene expression assays, or protein arrays.

21. The method of claim 1, comprising the additional step of conducting biological experiments designed to assess the validity of a proposed biological model.

22. A method of proposing new life-sciences related knowledge, the method comprising the steps of:
a) providing a case frame structure for life-science related concepts comprising
i) nodes representative of known life-sciences information selected from the group consisting of, conditions, processes, and physical structures, and
ii) case frames representative of interrelationships among nodes;
b) proposing a biological model using said case frame structure and specifying plural pairs of nodes and descriptors between selected nodes from said case frame structure;
c) simulating the proposed biological model to produce simulated data;
d) assigning a fitness measure to the proposed biological model as a measure of how the simulated data compares to said data representative of measured biological behavior or properties;
e) repeating steps b) through d) for a plurality of different proposed biological models; and
f) selecting one of said different proposed biological models in response to the fitness measures of said plurality of biological models.

23. The method of claim 22, wherein said biological model is proposed using an evolutionary algorithm.

24. The method of claim 22, wherein said biological model is proposed using genetic programming or a genetic algorithm.

25. The method of claim 22, wherein said biological model comprises a population of biological models.

26. The method of claim 22, wherein said method comprises an additional step of proposing new biological models using models simulated and scored in step d) by applying genetic algorithm crossover techniques.

27. The method of claim 26, wherein said genetic algorithm crossover techniques comprise mutation or probabilistic selection.

28. The method of claim 22, wherein said proposed biological model includes nodes of established position interconnected by established descriptors.

29. The method of claim 22, wherein said representation structure further comprises differential equations quantitatively representing possible relationship between pairs of nodes.

30. The method of claim 22, wherein qualitative simulation techniques are used to simulate the proposed model to produce simulated data.

31. The method of claim 22, comprising repeating said method using datasets probing disparate biological subsystems or substructures and combining models of said disparate subsystems or substructures into a consolidated model.

32. The method of claim 22, comprising repeating said method using datasets probing networks within a physiological pathway, cell compartment, cell, organism, population, or ecological system to discover subsystem networks, and combining disparate subsystem networks into a consolidated network.

33. The method of claim 22, wherein said nodes comprise enzymes, cofactors, enzyme substrates, enzyme inhibitors, DNAs, RNAs, transcription regulators, DNA activators, DNA repressors, signaling molecules, trans membrane molecules, transport molecules, sequestering molecules, regulatory molecules, hormones, cytokines, chemokines, antibodies, structural molecules, metabolites, vitamins, toxins, nutrients, minerals, agonists, antagonists, ligands, receptors, or combinations thereof.

34. The method of claim 22, wherein said nodes comprise protons, gas molecules, small organic molecules, amino acids, peptides, protein domains, proteins, glycoproteins, nucleotides, oligonucleotides, polysaccharides, lipids, glycolipids, or combinations thereof.

35. The method of claim 22, wherein said nodes comprise protein complexes, protein-nucleotide complexes, cell compartments, organelles, membranes, or combinations thereof.

36. The method of claim 22, wherein said nodes comprise descriptors or networks of nodes and descriptors comprising a substructure or sub-network of a biological system.

37. The method of claim 22, wherein said nodes comprise cells, tissues, or organs.

38. The method of claim 22, wherein said nodes comprise drug candidate molecules.

39. The method of claim 22, wherein said nodes are individuals of a species.

40. The method of claim 22, wherein said data representative of measured biological behavior or properties comprises data representative of experimental data, knowledge from the literature, patient data, clinical trial data, compliance data; chemical data, medical data, or hypothesized data.

41. The method of claim 22, wherein said data representative of measured biological behavior or properties comprises data acquired using PCR, qualitative PCR, gene expression assays, or protein arrays.

42. The method of claim 22, comprising the additional step of conducting biological experiments designed to assess the validity of a proposed biological model.
